(19) United States
(12) Patent Application Publication
(10) Pub. No.: US 2014/0311972 A1
(43) Pub. Date: Oct. 23, 2014

(54) NITRIFICATION METHOD AND SYSTEM

(71) Applicants: Malcolm Fabiyi, Chicago, IL (US); Asun Larrea, Tolosa (Gipuzkoa) (ES); Monica de Gracia, San Sebastian (Gipuzkoa) (ES)

(72) Inventors: Malcolm Fabiyi, Chicago, IL (US); Asun Larrea, Tolosa (Gipuzkoa) (ES); Monica de Gracia, San Sebastian (Gipuzkoa) (ES)

(21) Appl. No.: 14/244,164

(22) Filed: Apr. 3, 2014

Related U.S. Application Data
(60) Provisional application No. 61/813,234, filed on Apr. 18, 2013.

(51) Int. Cl. C02F 3/02

(52) U.S. Cl. CPC C02F 3/02
USPC 210/614; 210/620; 210/96.1

(57) ABSTRACT

A method and nitrification system for nitrifying a centrate stream produced from dewatering sludge within a wastewater treatment facility in which the centrate stream into a nitrification reactor containing accumulated centrate with a bacterial population of AOB and NOB nitrifying bacteria to the ammonia content within the centrate stream into nitrates and an oxygen containing gas is introduced into the accumulated centrate to support bacterial activity of the AOB and NOB nitrifying bacteria. Additionally, a conditioning method is obtained in which the bacterial population is grown within the nitrification reactor in conditioning stages that involve the introduction of incoming centrate into the reactor with a successively decreasing degree of dilution.

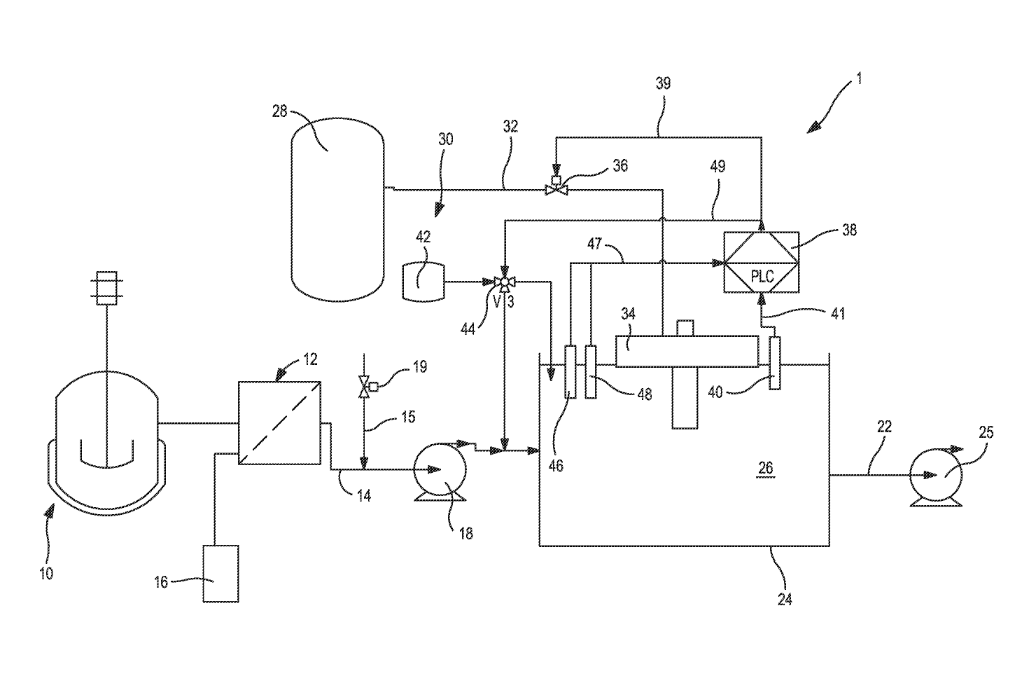

### RELATED APPLICATIONS

This application claims the benefit of U.S. Provisional Application Ser. No. 61/813,234, filed on Apr. 18, 2013, which is incorporated herein by reference.

### FIELD OF THE INVENTION

The present invention relates to a nitrification method and system for nitrifying a centrate stream produced from dewatering sludge within a wastewater treatment facility in which the ammonia content in the centrate is converted to nitrates within a reactor containing accumulated centrate with a population of Ammonia Oxidizing Bacteria (AOB) and Nitrite Oxidizing Bacteria (NOB) in sufficient proportions to convert at least 40.0 percent of ammonia content within the centrate stream into nitrates, dissolved oxygen levels are maintained therein that are greater than at least 3.0 mg/liter and the oxygen introduction into the accumulated centrate is controlled to obtain maximum bacterial activity. Additionally, the present invention relates to a conditioning method in which bacterial speciation is obtained that will be in sufficient portions to accomplish at least 80.0 percent ammonia conversion into nitrates.

### BACKGROUND OF THE INVENTION

Wastewater resulting from domestic and industrial waste is treated in waste water facilities in which the incoming waste water is treated so that it can safely be introduced into the environment. Typically, the waste water is treated in a primary clarifier to allow heavier solids to settle and lighter solids and liquid to float to the surface. In an activated sludge process, the remaining liquid is then subjected to further treatment in which bacterial action produced by bacteria contained in the activated sludge consumes soluble chemical oxygen demand present within the liquid. This takes place within an aeration basin and sludge contained in an effluent from such basin is allowed to settle in a secondary clarifier to produce a treated effluent. The settle sludge forms the activated sludge that is in part recycled to the aeration basin and is discharged as waste activated sludge. The waste activated sludge can then be further treated in a digester to remove the pathogenic content of the sludge and then to a dewatering system to produce a solid content that can be introduced into a landfill.

During the digestion process, there is an accumulation of ammonia in the centrate due to a release from hydrolyzed cells and thus, the centrate from the dewatering system contains a higher concentration of ammonia as compared with the wastewater entering the plant. Typically this centrate is recycled back to the primary clarifier and can represent as much as 20 to 30 percent or more of the ammonia load to the wastewater treatment plant. The untreated ammonia will be discharged from the plant in the effluent from the secondary clarifier. This becomes a problem in that such ammonia can potentially supply nitrogen that can stimulate unwanted plant growth and produce toxic conditions for other aquatic life. Therefore, there exists a need, if not a regulatory requirement in many jurisdictions, to remove the nitrogen before discharging the effluent. Typically, the removal of nitrogen is effected through the oxidation of ammonia to nitrates in a two step process in which the ammonia is first oxidized to nitrites by means of ammonia oxidizing bacteria known as AOB bacteria and then oxidizing the nitrites to nitrates by means of nitrite oxidizing bacteria known as NOB bacteria. The resulting nitrates are bacterially reduced to nitrogen gas under anoxic conditions. Since the AOB and NOB bacteria have a longer growth period than bacteria that will remove chemical oxygen demand, in order to accommodate the removal of ammonia from the facility, longer solid retention times will be necessary, resulting in an increase in the size of facility and/or an increase in the solids concentration in the aeration basin. However, in most plants solids loading constraints in the secondary clarifier limit the ability to increase solid concentrations as an effective means for increasing solids retention times.

The foregoing problem will be alleviated, by oxidizing the ammonia in the centrate stream so that the ammonia is not reintroduced into the facility. However, it has been found that it is not a strait forward matter to use AOB and NOB bacteria in a separate reactor for such purpose without the reactor itself taking up a large foot print. The reason for this is that while it is known that the activity of such bacteria can be increased by increasing dissolved oxygen levels, when this is done, the increased concentration of nitrites under such circumstances can lead to the formation of free nitrous acid which is known to inhibit the nitrification process.

The present invention, allows the centrate to be practically treated within a nitrification reactor with enhanced oxidation rates of ammonia and with loadings beyond those currently obtained in the art through the use of conditioned bacterial populations and the use of appropriate dissolved oxygen levels.

### SUMMARY OF THE INVENTION

The present invention provides a method of nitrifying a centrate stream produced from dewatering sludge within a wastewater treatment facility. In accordance with such method, the centrate stream is introduced into a nitrification reactor containing accumulated centrate with a bacterial population of AOB and NOB nitrifying bacteria in sufficient proportions to convert at least 40.0 percent of an ammonia content within the centrate stream into nitrates and has a volume sufficient to treat a loading of between 500.0 and 5,000.0 g NH4-N/m³·day introduced into the volume by the centrate stream. Here, it is appropriate to point out that the use of the term “centrate stream” is not meant to limit the application of the present invention to streams produced by wastewater treatment facilities designed to only treat sewage and municipal wastes in that the present invention has equal application to the treatment of industrial (such as dairy and poultry) wastewater streams or in fact, any stream having a high ammonia loading.

An oxygen containing gas is introduced into the accumulated centrate within the nitrification reactor such that dissolved oxygen levels are maintained therein that are greater than at least 3.0 mg/liter and less than that which would produce toxic conditions for the AOB and NOB nitrifying bacteria. Part of the ammonia content within the accumulated centrate is converted to nitrates within the nitrification reactor and a treated centrate stream is discharged from the nitrification reactor having an ammonia concentration no greater than 60.0 percent of the ammonia content of the centrate stream introduced into the nitrification reactor. It is understood herein and in the claims, that the introduction of the oxygen containing gas into the accumulated centrate could be accomplished by directly dissolving oxygen into the accumulated centrate within the reactor or into a side stream of the accumulated centrate that is removed and then reintroduced back into the reactor.

It is to be noted that a dissolved oxygen level within the accumulated centrate that is measured is a residual oxygen level that is obtained after the bacteria have consumed oxygen required for biological activity. It has been found by the inventors herein that with greater dissolved oxygen levels, greater bacterial activity can be supported. Further, in most reactor systems without adding any supplemental alkalinity, the present invention is able to obtain a 40 percent conversion of ammonia to nitrates. Typically, centrate streams have sufficient alkalinity to support such a conversion. It is to be noted, however, that if alkalinity were added in such a reactor system together with additional oxygen far greater conversions are possible. However, whether or not alkaline substances such as bicarbonate are added, by conditioning the bacterial population, greater ammonia loading rates within the incoming centrate stream can be converted to nitrates because there are sufficient NOB bacteria to oxidize the nitrites produced by the AOB bacteria. This will translate to smaller reactor volumes and footprints for the equipment that is used in nitrifying the ammonia content of the centrate.

Preferably, the bacterial population of AOB and NOB nitrifying bacteria is sufficient to convert at least 90.0 percent of the ammonia content within the centrate stream into nitrates and the dissolved oxygen level can be maintained at between 10.0 and 20.0 mg/liter. Further, the oxygen containing gas that is introduced into the accumulated centrate within the nitrification reactor is a gas stream having an oxygen concentration of no less than 50.0 percent by volume.

The dissolved oxygen levels are maintained by controlling the flow rate of the oxygen containing gas to obtain target dissolved oxygen levels within the accumulated centrate. The target dissolved oxygen levels are increased from an initial dissolved oxygen level calculated to produce a maximum level of bacterial activity until bacterial activity decreases or stabilizes and after bacterial activity decreases or stabilizes, the target dissolved oxygen level is reduced to a prior target dissolved oxygen level that was obtained prior to the decrease or stabilization in the bacterial activity. Further, periodically, the target dissolved oxygen level can be increased from the prior dissolved oxygen level until the bacterial activity decreases or stabilizes and then, after bacterial activity decreases or stabilizes, reducing the target dissolved oxygen level to a new level, higher than the prior target dissolved oxygen level that was set prior to the decrease in or the stabilization of the bacterial activity. Preferably, the target dissolved oxygen level is increased, by incrementally increasing the target dissolved oxygen level, measuring the dissolved oxygen level and controlling the flow rate of the oxygen containing gas to maintain the dissolved oxygen level at each of the targets. Bacterial activity is measured after each of the targets has been achieved by suspending the introduction of the oxygen containing gas into the reactor, recording a series of measurements of the dissolved oxygen levels and determining an oxygen utilization rate. A current value of the oxygen utilization rate, determined after each of the targets has been achieved, is compared with a previous value of the oxygen utilization rate determined after a previous target has been achieved. As a result of such comparison, any increase in the oxygen utilization rate is used as an increased measure of bacterial activity, any decrease in the oxygen utilization rate is used as a decreased measure of the bacterial activity, and the stabilization in the oxygen utilization rate is used as a measure of the stabilization of the bacterial activity. A decrease in bacterial activity is also a potential indicator of developing toxic conditions for the AOB and NOB nitrifying bacteria. As will be discussed, the present invention also encompasses a method in which the dissolved oxygen level is reduced to a level of no greater than 2.0 mg/liter to reduce activity of the NOB bacteria such that the ammonia content within the centrate stream is predominantly converted into nitrites.

The present invention also provides a method of conditioning to achieve bacterial speciation within a nitrification reactor. In accordance with such method, a centrate stream, obtained by dewatering sludge, is diluted to produce a diluted centrate stream. The diluted centrate stream is introduced into the nitrification reactor to produce accumulated centrate within the nitrification reactor. An oxygen containing stream is introduced into the nitrification reactor to promote bacterial activity within the nitrification reactor and conversion of ammonia contained in the centrate stream to nitrates. A treated centrate stream is discharged from the nitrification reactor having an ammonia concentration lower than that of the diluted centrate stream. The dilution of the centrate stream is incrementally reduced in successive stages of dilution until the centrate stream in an undiluted state is introduced into the nitrification reactor. During each of the successive stages of dilution a population of AOB and NOB bacteria within the accumulated centrate is obtained that will produce an increasing conversion of the ammonia to nitrates and a decreasing concentration of nitrites within the accumulated centrate and before proceeding to each successive incremental decrease in the dilution, a conversion of at least 80 percent of the ammonia within the diluted centrate stream to the nitrates is also obtained.

Preferably, the dilution of the centrate stream is incrementally decreased in successive stages of dilution by initially diluting the centrate stream so that the ammonia load to the nitrification reactor is 50.0 g ammonia-N/m³/day and then, decreasing the dilution so that the ammonia load increases at a rate of 50.0 g ammonia-N/m³/day. Also, the oxygen containing stream is introduced into the nitrification reactor to reach an initial value of 3.0 mg/l of dissolved oxygen, and the introduction is thereafter increased such as to reach 5.0 mg/liter dissolved oxygen when the ammonia load is 100.0 g ammonia-N/m³/day. The introduction of the oxygen containing stream is increased to a level to reach a dissolved oxygen of between 8.0 and 20.0 mg/liter in the accumulated centrate when the ammonia load is equal to or greater than 200.0 g ammonia-N/m³/day.

The present invention further provides a nitrification system for nitrifying a centrate stream produced from dewatering sludge within a wastewater treatment facility. The nitrification system comprises a reactor for receiving the centrate stream and containing accumulated centrate and having an outlet for discharging a treated centrate stream. The accumulated centrate having a bacterial population of AOB and NOB nitrifying bacteria in sufficient proportions to convert at least 40.0 percent of an ammonia content within the centrate stream into nitrates. The nitrification reactor has a volume sufficient to treat a loading of between 500.0 and 5,000.0 g NH4-N/m³·day introduced into the volume by the centrate stream. A means is provided for supplying and introducing an oxygen containing gas into the accumulated centrate and a means is also provided for controlling the oxygen containing gas supply and introduction means and therefore the introduction of the oxygen containing gas. The oxygen containing gas supply and introduction means functions such that dissolved oxygen levels that are maintained within the accumulated centrate are greater than at least 3.0 mg/liter and less than that which would produce toxic conditions for the AOB and NOB nitrifying bacteria and the treated centrate stream has an ammonia concentration no greater than t 60.0 percent of the ammonia content of the centrate stream introduced into the reactor.

The oxygen containing gas supply and introduction means can be responsive to an oxygen control signal referable to a target dissolved oxygen level and regulates flow rate of the oxygen containing gas introduced into the accumulated centrate in response to the oxygen control signal. The control means comprises an oxygen sensor and a controller. The oxygen sensor senses dissolved oxygen levels within the accumulated centrate and generates a dissolved oxygen signal referable to the dissolved oxygen levels within the accumulated centrate. The controller is responsive to the dissolved oxygen signal and is programmed to generate the oxygen control signal referable to the target dissolved oxygen level that will maintain the dissolved oxygen levels greater than at least 3.0 mg/liter and less than that which would produce toxic conditions for the AOB and NOB nitrifying bacteria in the treated centrate stream. Preferably, the control program is programmed such that the target dissolved oxygen levels are incrementally increased from an initial dissolved oxygen level calculated to produce a maximum level of bacterial activity until bacterial activity decreases or stabilizes. After bacterial activity decreases or stabilizes, the target dissolved oxygen level is reduced to a prior target dissolved oxygen level that was obtained prior to the decrease or stabilization in the bacterial activity. Periodically, the target dissolved oxygen level is increased from the prior dissolved oxygen level until the bacterial activity decreases or stabilizes and then, after bacterial activity decreases or stabilizes, reducing the target dissolved oxygen level to a new level, higher than the prior target dissolved oxygen level that was obtained prior to the decrease in or stabilization of the bacterial activity. When each of the target dissolved oxygen levels has been achieved, the oxygen control signal is generated to suspend the introduction of the oxygen containing gas into the reactor, the dissolved oxygen level as measured by the sensor is recorded in a series of measurements of the dissolved oxygen level and a current oxygen utilization rate is calculated from a rate of change of the dissolved oxygen levels and stored. The current value of the oxygen utilization rate is compared with a previous value of the oxygen utilization rate and is utilized as the measure of bacterial activity. Any increase in the oxygen utilization rate is an increased measure of bacterial activity, any decrease in the oxygen utilization rate is a decreased measure of the bacterial activity and any stability in the oxygen utilization rate is an indication that the bacterial activity has stabilized or in other words, has reached a plateau.

The oxygen containing gas supply and introduction means can include a source of an oxygen containing gas, an oxygen injection device to inject the oxygen containing gas into the accumulated centrate, a conduit connecting the source of the oxygen containing gas to the oxygen injection device and a remotely activated flow control valve to control the flow of the oxygen containing gas in the conduit. A PID (proportional, integral and derivative) controller responsive to the oxygen control signal and the dissolved oxygen signal to control opening of the remotely activated control valve is operated such that the dissolved oxygen level as measured by the sensor at least approaches the target dissolved oxygen level calculated by the controller.

### BRIEF DESCRIPTION OF THE DRAWINGS

While the specification concludes with claims distinctly pointing out the subject matter that Applicants regard as their invention, it is believed that the invention will be better understood when taken in connection with the sole accompanying drawing which is a schematic process flow diagram of a nitrification reactor and system to carry out a method in accordance with the present invention.

### DETAILED DESCRIPTION

With reference to the sole FIGURE, a nitrification system 1 is illustrated in which sludge that is produced in the waste water process is treated by bacteria in a digester 10 to reduce the organic matter and potentially hazardous organisms present within the solids making up the sludge. Thereafter, the sludge is dewatered in a dewatering system 12 that produces a centrate stream 14 and cake 16 that can be transported to a landfill or other final disposal. Dewatering system 12 is typically a screw press or belt filter or centrifuge. The centrate stream 14 is pumped by means of a pump 18 and introduced into a nitrification system 1 that acts to convert the ammonia content of the centrate stream 14 to nitrates and nitrites. The resulting treated centrate stream 22 can be pumped by a pump 25 for reintroduction into a secondary treatment system upstream of an aerobic basin to allow the nitrates to be consumed by denitrifying bacteria and converted to nitrogen gas that can be released from the wastewater treatment facility. It is to be noted that where the combination of the centrate and the treated waste water stream meet regulatory requirements, the treated centrate stream 22 can simply be mixed with the treated effluent and directly discharged.

Nitrification system 1 is designed to take advantage of high dissolved oxygen levels in treating the centrate and thereby allow such system to be designed with a much smaller footprint than nitrification systems of the prior art. The nitrification system 1 includes a nitrification reactor 24 containing accumulated centrate 26. Although not specifically illustrated, the nitrification reactor 24 also contains an initial quantity of seed sludge from the plant that supplies the bacteria to treat the centrate stream 14. The reactor volume is sufficient to treat between 500.0 to 5,000.0 g NH4-N/m3·day with a target Hydraulic Retention Time (HRT) of 0.5 to two days based on centrate flow. In order to allow the high dissolved oxygen levels within the accumulated centrate 26 to be effectively utilized by the bacteria, bacterial population must be conditioned to produce a speciation of AOB and NOB bacteria to convert at least 80 percent of the incoming ammonia to nitrates. At the same time an oxygen containing stream is also introduced into the nitrification reactor 24 to promote bacterial activity within the nitrification reactor 24 and conversion of ammonia contained in the centrate stream 14 to nitrates. The conditioning is carried out by diluting the centrate stream with a diluent stream 15 having a flow rate controlled by a control valve 19 and incrementally decreasing dilution of the centrate stream 14 in successive stages of dilution until the centrate stream in an undiluted state is introduced into the nitrification reactor 24 when conditioning is complete. In this regard, the diluent stream 15 that can be plant effluent from the secondary clarifier or other low ammonia water stream. The incremental decreasing dilutions are carried out by measuring the ammonia content in the incoming centrate stream 14 after having been diluted with diluent stream 15 and the ammonia content within the treated centrate stream 22. In addition the nitrite and nitrate concentrations within the accumulated centrate 26 are also measured. These measurements can be carried out by sampling or on-line sampling probes that are well known in the art. When a continual decrease in the concentration of nitrites is observed and a conversion of at least 80 percent of the ammonia within the accumulated centrate that is either directly measured in accumulated centrate 26 or in the treated centrate stream 22 is obtained, the next dilution state is conducted with a lower amount of dilution.

In order for the nitrification reactor 24 to have a reasonable footprint, the conversion of the ammonia to nitrates has to be accomplished within a set time period. Therefore, the loading protocol during the acclimation phase requires maintaining a loading rate of ammonia (gN/m3·day) while also maintaining a specific hydraulic retention time, “HRT”. For instance, the centrate load can be reduced by simply reducing the quantity of centrate charged to the nitrification reactor, however, this would significantly affect the HRT. In this regard, if only ten percent of the centrate stream is sent to the nitrification reactor 24, then the loading requirement might be met, however, given that the nitrification reactor 24 is designed usually for about 1 day HRT, then this would imply that the effective HRT is 10 days. In other words, for a 100,000 gal reactor designed to treat 100,000 gal/day centrate, the HRT is 1 day. If the centrate load were merely reduced to a tenth of its value without dilution, then only 10,000 gal of centrate would be charged to the nitrification reactor 24, and the resultant HRT (given as reactor volume/flow rate i.e., 100,000 gal/10,000 gal·day) is 10 days. A diluent stream, usually comprising effluent water from the treatment plant is used to bring centrate ammonia load to an acceptable range, as well as to satisfy the HRT requirement. The Table below gives a typical range of ammonia loading rates and target HRT values in the nitrification reactor during start-up.

It has been experimentally determined that the dilution of the centrate stream is incrementally decreased in successive stages of dilution by initially diluting the centrate stream so that the ammonia load to the nitrification reactor is 50.0 g ammonia-N/m³/day and then, decreasing the dilution so that the ammonia load increases at a rate of 50.0-100.0 g ammonia-N/m³/day. At the same time, the oxygen containing stream is introduced into the nitrification reactor to reach an initial value of 3.0 mg/liter DO (dissolved oxygen), and is thereafter increased to reach 5.0 mg/liter DO when the ammonia load is 100.0 g ammonia-N/m³/day and is further increased to reach a DO level of between 8.0 and 20.0 mg/liter when the ammonia load is equal to or greater than 200.0 g ammonia-N/m³/day. As can be appreciated, these foregoing values of ammonia loading and DO levels might be in practice varied with process requirements. The following table therefore, illustrates an example of the conditioning step.

TABLE

| | | | | | | Duration of | Implied |
|---|---|---|---|---|---|---|---|
| | Influent | Hydraulic | Nitrate (at | | | step (day | Loading |
| | Ammonia | Retention | end of | DO Level | Temperature | before next | rate (g NH₄- |
| Step | (mg/l) | Time (d) | Step) (mg/l) | (mg/l) | ° C. | increase) | N/m³ · day) |
| No. 1 | 150 | 3 | 140 | 3 | 25 | 7 | 50 |
| No. 2 | 300 | 3 | 289 | 5 | 25 | 7 | 100 |
| No. 3 | 450 | 3 | 437 | 8 | 25 | 7 | 150 |
| No. 4 | 600 | 3 | 585 | 8 | 25 | 7 | 200 |
| No. 5 | 750 | 3 | 733 | 10 | 25 | 7 | 250 |
| No. 6 | 900 | 3 | 881 | 10 | 25 | 7 | 300 |
| No. 7 | 1000 | 3 | 980 | 10 | 25 | 21 | 333 |
| No. 8 | 1000 | 2.5 | 980 | 10 | 25 | 21 | 400 |
| No. 9 | 1000 | 2 | 980 | 10 | 25 | 21 | 500 |

Once the bacteria contained in the nitrification reactor 26 has been conditioned, the nitrification system 1 is operated with loading rates of greater than 200.0 gN/m3·day; with targeted N removal rates of 500.0-5000.0 g N/m3·day and dissolved oxygen level of greater than 3.0 mg/l, with maximum at 45.0 mg/liter and in any case, less than that which would produce toxic conditions for the bacteria.

The oxygen is dissolved into the accumulated centrate 26 by means of an oxygen supply and introduction system consisting of an oxygen source which can be an oxygen tank 28 connected to an atmospheric vaporizer 30 to produce a gaseous oxygen stream flowing within a conduit 32 to an oxygen injection device 34. The gaseous oxygen stream should contain at least 50.0 percent by volume oxygen and therefore, could be oxygen enriched air or a vent gas from another oxygen consuming process. The oxygen injection device can be of the type in which the oxygen gas is introduced into a headspace located within a ballast chamber. A draft tube is connected to the ballast chamber and an impeller located in the draft tube and driven by a motor. The accumulated centrate 26 is drawn into one end of the draft tube along with the oxygen from the headspace and a resulting liquid gas mixture is discharged from the other end of the draft tube.

The flow rate of the oxygen injected is controlled by a valve 36 located within the conduit 32. Valve 36 is a remotely activated flow control valve having a valve opening controlled by a controller generally indicated by reference number 38 connected to valve 26 by an electrical conductor 39. The controller has two components, a master controller, programmed with a control program to in turn generate targets of dissolved oxygen for a local controller, for instance a PID controller, that controls the opening of valve 36. An oxygen sensor 40 measures the dissolved oxygen levels within the accumulated centrate to in turn generate a dissolved oxygen signal that is transmitted by an electrical connection 41 to serve as an input into the oxygen controller 40 both for purposes of master control and setting targets for dissolved oxygen levels and for response of the local controller to obtain such dissolved oxygen levels through appropriate valve openings of the valve 36.

An input to the master controller is an initial target of the dissolved oxygen that is calculated to produce a maximum level of bacterial activity. This initial value is set at an initial value between 3.0 and 10.0 mg/l. Thereafter, the initial target is incrementally increased, by for instance, raising the target DO set point in increments of 2.0 mg/l. An oxygen control signal referable to the current target value is then generated by the master controller and inputted into the local controller. Once a particular target has been obtained, the master controller generates an oxygen control signal closing the valve 36. At this point a series of dissolved oxygen measurements are performed by oxygen sensor 40 and inputted and recorded in the master controller. A rate of change is then calculated by the control programming and such rate of change is taken as an oxygen uptake rate and as a measure of bacterial activity. The current value of the oxygen uptake rate is then compared with a previous value. If an increase is seen, then this is taken as an increase in bacterial activity and a new target for the dissolved oxygen is set. This process is repeated until either the oxygen uptake rate is seen to decline or remains stable. The decline is seen as a decrease in bacterial activity and a stable reading is indicative of a plateau of bacterial activity having been reached. In any case, if a decline or stabilization is reached, the new target for the dissolved oxygen level will be the previous target. Periodically this process is repeated to increase the target for the dissolved oxygen until a decrease or plateau is reached in bacterial activity. When this subsequently occurs, the target is decreased to a new prior target that is higher than the prior target dissolved oxygen level that was obtained prior to the decrease or stabilization in the bacterial activity. In this manner, maximum dissolved oxygen levels are able to be attained. A minimum and maximum range around the target are specified in the PLC controller to maintain appropriate response curves for the determination of oxygen uptake rate. Although not illustrated, optionally the temperature within the nitrification reactor 24 could be controlled by directly heating or cooling the accumulated centrate 26 or the influent centrate to be treated. A preferred temperature treatment range would be between 20° C. and 30° C.

It is important to prevent the accumulated centrate 26 from becoming too acidic. As can be appreciated, the nitrifying microorganisms consume alkalinity which reduces the buffering capacity of the centrate liquor in the nitrification reactor, leading to a drop in pH. In order to prevent this, an alkalinity source 42 is provided to optionally provide a buffer to ensure that pH can be maintained between 6.5 to 7.5. In this regard, a two-way valve 44 can be provided to introduce the buffer into either the incoming centrate stream 14 or directly into the accumulated centrate 26. The amount of buffer, usually carbonate salt, that is added is determined by estimating the difference between the alkalinity required to nitrify the ammonia contained in the centrate entering the nitrification reactor 24 and the amount of alkalinity naturally occurring in the entering centrate. The operation can be automatically controlled by means of pH sensor 46 that senses pH levels in the reactor and supplies the same to controller 38 as an input by a conductor 47. The controller 38 then modulates the valve 44 through an electrical connection 49 to provide sufficient alkalinity to maintain a target pH level. Also an optional oxidation reduction potential sensor 48 could be used to measure the oxic state of the system for purposes of enhanced control of the oxic state of the system, beyond that offered by a DO probe, especially where periodic swings from aerobic to anoxic states are implemented, to allow for denitrification in the same reactor system. It is to be noted that the present invention contemplates embodiments in which no supplemental alkalinity is add. In such case, the bacterial population of AOB and NOB nitrifying bacteria should be in sufficient proportions to convert at least 40.0 percent of an ammonia content within the centrate stream 14 into nitrates and having a volume sufficient to treat a loading of between 500.0 and 5000.0 g NH₄-N/m³·day introduced into the volume through the centrate stream 14. The treated centrate stream 22 discharged from the nitrification reactor 24 would have an ammonia concentration of no greater than 60.0 percent of ammonia content of the centrate stream introduced into the nitrification reactor. Expected dissolved oxygen levels would be maintained at a level of greater than 3.0 mg/liter, but less than that which would produce toxic conditions for the AOB and NOB nitrifying bacteria. However, where a buffering agent is introduced, the bacterial population of AOB and NOB nitrifying bacteria would be expected to be sufficient to convert at least 90.0 percent of the ammonia content within the centrate stream 14 into nitrates. In such case, the dissolved oxygen level would be maintained at between 10.0 and 20.0 mg/liter.

Where there are no regulatory limits on nitrites and/or it would be determined that there is no deleterious impact of nitrites within the aerobic basin, complete oxidation of ammonia to nitrates might not be necessary. In such cases, it would be sufficient to partially oxidize the ammonia to nitrites. As such, once AOB and NOB bacterial populations have been sufficiently grown to oxidize the ammonia to nitrates, the dissolved oxygen level within the nitrification reactor can be reduced to a level of no greater than 2.0 mg/liter and thereby reduce activity of the NOB bacteria such that the ammonia content within the centrate stream is predominantly converted into nitrites.

Although the present invention has been described with reference to a preferred embodiment, as would occur to those skilled in the art, numerous changes, omissions and additions thereof could be made within the spirit and scope of the presently appended claims.

We claim:

1. A method of nitrifying a centrate stream produced from dewatering sludge within a wastewater treatment facility, said method comprising:
introducing the centrate stream into a nitrification reactor containing accumulated centrate with a bacterial population of AOB and NOB nitrifying bacteria in sufficient proportions to convert at least 40.0 percent of an ammonia content within the centrate stream into nitrates and having a volume sufficient to treat a loading of between 500.0 and 5000.0 g NH₄-N/m³·day introduced into the volume through the centrate stream;
introducing an oxygen containing gas into the accumulated centrate within the nitrification reactor such that dissolved oxygen levels are maintained therein that are greater than at least 3.0 mg/liter and less than that which would produce toxic conditions for the AOB and NOB nitrifying bacteria;
converting part of the ammonia content within the accumulated centrate to nitrates within the nitrification reactor; and
discharging a treated centrate stream from the nitrification reactor having an ammonia concentration of no greater than 60.0 percent of ammonia content of the centrate stream introduced into the nitrification reactor.

2. The method of claim 1, wherein:
the bacterial population of AOB and NOB nitrifying bacteria is sufficient to convert at least 90.0 percent of the ammonia content within the centrate stream into nitrates; and
the dissolved oxygen level is maintained at between 10.0 and 20.0 mg/liter.

3. The method of claim 2, wherein the oxygen containing gas is introduced into the accumulated centrate within the nitrification reactor by introducing an oxygen stream into the accumulated centrate having an oxygen concentration of no less than 50.0 percent by volume.

4. The method of claim 3, wherein:
dissolved oxygen levels are maintained by controlling flow rate of the oxygen stream to obtain target dissolved oxygen levels within the accumulated centrate;
the target dissolved oxygen levels are increased from an initial dissolved oxygen level calculated to produce a maximum level of bacterial activity until bacterial activity decreases or stabilizes; and
after bacterial activity decreases or stabilizes, reducing the target dissolved oxygen level to a prior target dissolved oxygen level that was obtained prior to the decrease or the stabilization of the bacterial activity.

5. The method of claim 4, wherein, periodically, the target dissolved oxygen level is increased from the prior dissolved oxygen level until the bacterial activity decreases or stabilizes and then, after bacterial activity decreases or stabilizes, reducing the target dissolved oxygen level to a new level, higher than the prior target dissolved oxygen level that was obtained prior to the decrease in or the stabilization of the bacterial activity.

6. The method of claim 4 or claim 5, wherein:
the target dissolved oxygen level is increased, by incrementally increasing the target dissolved oxygen level, measuring the dissolved oxygen level and controlling the flow rate of the oxygen containing gas to maintain the dissolved oxygen level at each of the targets;
measuring the bacterial activity after each of the targets has been achieved by suspending the introduction of the oxygen containing gas into the reactor, recording a series of measurements of the dissolved oxygen levels and determining an oxygen utilization rate; and
comparing a current value of the oxygen utilization rate determined after each of the targets has been achieved with a previous value of the oxygen utilization rate determined after a previous target has been achieved and utilizing any increase in the oxygen utilization rate as an increased measure of bacterial activities, any decrease in the oxygen utilization rate as a decreased measure of bacterial activity and any stability in the oxygen utilization rate as a measure of the bacterial activity reaching a plateau.

7. The method of claim 1, wherein the dissolved oxygen level is reduced to a level of no greater than 2.0 mg/liter to reduce activity of the NOB bacteria such that the ammonia content within the centrate stream is predominantly converted into nitrites.

8. A method of conditioning bacterial speciation within a nitrification reactor comprising:
diluting a centrate stream obtained by dewatering sludge to produce a diluted centrate stream and introducing the diluted centrate stream into the nitrification reactor to produce accumulated centrate within the nitrification reactor;
introducing an oxygen containing stream into the nitrification reactor to promote bacterial activity within the nitrification reactor and conversion of ammonia contained in the centrate stream to nitrates;
discharging a treated centrate stream from the nitrification reactor having an ammonia concentration lower than that of the diluted centrate stream;
incrementally decreasing dilution of the centrate stream in successive stages of dilution until the centrate stream in an undiluted state is introduced into the nitrification reactor;
during each of the successive stages of dilution obtaining a population of AOB and NOB bacteria within the accumulated centrate that will produce an increasing conversion of the ammonia to nitrates and a decreasing concentration of nitrites within the accumulated centrate; and
before proceeding to each successive incremental decrease in the dilution, obtaining a conversion of at least 80.0 percent of the ammonia within the diluted centrate stream to the nitrates.

9. The method of claim 8, wherein:
the dilution of the centrate stream is incrementally decreased in successive stages of dilution by initially diluting the centrate stream so that the ammonia load to the nitrification reactor is 50.0 g ammonia-N/m³/day and then, decreasing the dilution so that the ammonia load increases at a rate of 50.0-100.0 g ammonia-N/m³/day; and
the oxygen containing stream is introduced into the nitrification reactor to reach an initial value of 3.0 mg/l of dissolved oxygen, and is thereafter increased to reach 5.0 mg/liter of dissolved oxygen when the ammonia load is 100.0 g ammonia-N/m³/day and is increased to a level of between 8.0 and 20.0 mg/liter dissolved oxygen when the ammonia load is equal to or greater than 200.0 g ammonia-N/m³/day.

10. A nitrification system for nitrifying a centrate stream produced from dewatering sludge within a wastewater treatment facility, said nitrification system comprising:
a reactor for receiving the centrate stream and containing accumulated centrate and having an outlet for discharging a treated centrate stream;
the accumulated centrate having a bacterial population of AOB and NOB nitrifying bacteria in sufficient proportions to convert at least 40.0 percent of an ammonia content within the centrate stream into nitrates;
the nitrification reactor having a volume sufficient to treat a loading of between 500.0 and 5000.0 g NH₄-N/m³·day introduced into the volume through the centrate stream;
means for supplying and introducing an oxygen containing gas into the accumulated centrate; and
means for controlling the oxygen containing gas supply and introduction means and therefore the introduction of the oxygen containing gas such that dissolved oxygen levels are maintained within the accumulated centrate that are greater than at least 3.0 mg/liter and less than that which would produce toxic conditions for the AOB and NOB nitrifying bacteria and the treated centrate stream has an ammonia concentration of no greater than 60.0 percent of ammonia content of the centrate stream introduced into the reactor.

11. The nitrification system of claim 10, wherein:
the oxygen containing gas supply and introduction means is responsive to an oxygen control signal referable to a target dissolved oxygen level and regulates flow rate of the oxygen containing gas introduced into the accumulated centrate in response to the oxygen control signal; and
the control means comprises an oxygen sensor to sense dissolved oxygen levels within the accumulated centrate and to generate a dissolved oxygen signal referable to the dissolved oxygen levels within the accumulated centrate and a controller, responsive to the dissolved oxygen signal and programmed to generate the oxygen control signal referable to the target dissolved oxygen level that will maintain the dissolved oxygen levels greater than at least 3.0 mg/liter and less than that which would produce toxic conditions for the AOB and NOB nitrifying bacteria.

12. The nitrification system of claim 11, wherein the control program is programmed such that:
the target dissolved oxygen levels are incrementally increased from an initial dissolved oxygen level calculated to produce a maximum level of bacterial activity until bacterial activity decreases or reaches a plateau;
after bacterial activity decreases or reaches a plateau, the target dissolved oxygen level is reduced to a prior target dissolved oxygen level obtained prior to the decrease or stabilization in the bacterial activity;
periodically, the target dissolved oxygen level is increased from the prior dissolved oxygen level until the bacterial activity decreases or stabilizes and then, after bacterial activity decreases or stabilizes, reducing the target dissolved oxygen level to a new level higher than the prior target dissolved oxygen level that was obtained prior to the decrease or stabilization in the bacterial activity; and
when each of the target dissolved oxygen levels has been achieved, the oxygen control signal is generated to suspend the introduction of the oxygen containing gas into the reactor, the dissolved oxygen level as measured by the sensor is recorded in a series of measurements of the dissolved oxygen level and a current oxygen utilization rate is calculated from a rate of change of the dissolved oxygen levels and stored; and
the current value of the oxygen utilization rate is compared with a previous value of the oxygen utilization rate and is utilized such that any increase in the oxygen utilization rate is an increased measure of bacterial activity, any decrease in the oxygen utilization rate is a decreased measure of the bacterial activity and any stability in the oxygen utilization rate is a measure of the bacterial activity reaching a plateau.

13. The nitrification system of claim 12, wherein the oxygen containing gas supply and introduction means comprises:
a source of an oxygen containing gas;
an oxygen injection device to inject the oxygen containing gas into the accumulated centrate;
a conduit connecting the source of the oxygen containing gas to the oxygen injection device and a remotely activated flow control valve to control the flow of the oxygen containing gas in the conduit; and
a PID controller responsive to the oxygen control signal and the dissolved oxygen signal to control opening of the remotely activated control valve such that the dissolved oxygen level as measured by the sensor at least approaches the target dissolved oxygen level calculated by the controller.
